(19) United States
(12) Patent Application Publication
(10) Pub. No.: US 2025/0256274 A1
(43) Pub. Date: Aug. 14, 2025

(54) Pipette

(71) Applicant: Seitz Hiemer Sogaro GbR, Dürrwangen (DE)

(72) Inventors: Andreas Hiemer, Hamburg (DE); Alberto C. Sogaro, Bad Homburg (DE); Sebastian Seitz, Dürrwangen (DE)

(21) Appl. No.: 19/046,734

(22) Filed: Feb. 6, 2025

(30) Foreign Application Priority Data
Feb. 9, 2024 (EP) 24156730.4
Jan. 16, 2025 (EP) 25152236.3

(51) Int. Cl. B01L 3/02

(52) U.S. Cl. CPC B01L 3/0217; B01L 2300/044; B01L 2300/047; B01L 2400/0481

(57) ABSTRACT

A pipette comprising an ampule closed on all sides, the ampule having a reservoir space in which a liquid is held and which is delimited by an at least essentially cylindrical circumferential wall of the ampule. The ampule has at least one break-off end area, in which breaking off of the end area opens an outlet opening for the liquid. A pipette member being provided in which the pipetting member is formed by an elastically deformable element and is plugged onto the ampule in such a manner that it circumferentially delimits the cylindrical circumferential wall and the ampule, which is closed on all sides and filled with the liquid, is partially exposed.

### CROSS-REFERENCE TO RELATED APPLICATION

This application claims priority to European patent application no. 24156730.4 filed Feb. 9, 2024, and European patent application no. 25152236.3 filed Jan. 16, 2025, the disclosure of which are incorporated herein by reference in their entirety for all purposes.

### TECHNICAL FIELD

The invention relates to a pipette.

### BACKGROUND

Pipettes are known from practice and typically comprise a tubular reservoir body, which can be made of glass or plastic. The reservoir body is provided with a discharge opening at one end. At the end facing away from the discharge opening, the reservoir body is provided with an operating element, which is formed by a balloon-like, rubber-elastic element, operation of which allows a liquid to be drawn into the reservoir body via the discharge opening and a liquid then held in the reservoir body to be applied in a suitable manner. Pipettes of this kind are used in the medical field and also in chemical laboratories.

### SUMMARY

The object of the disclosure is to provide a pipette that is characterized by simple use and suitable for applying specific liquids.

So the disclosure proposes a pipette comprising an ampule closed on all sides, the ampule having a reservoir space in which a liquid is held and which is limited by an at least essentially cylindrical circumferential wall of the ampule. The ampule has at least one break-off end area, breaking off of which opens an outlet opening for the liquid. Moreover, the pipette has a pipetting member which is made of an elastically deformable element and which is plugged onto the ampule in such a manner that it circumferentially limits the cylindrical circumferential wall and the ampule, which is closed on all sides and filled with the liquid, is partially exposed.

In the form of the pipette according to the disclosure, a prefilled pipette is provided in which the liquid, e.g., a chemical substance, a cosmetic substance or a medical substance, to be applied to a substrate is already present and in which part of the ampule is always uncovered by the material of the elastically deformable element. The liquid can be applied by means of the pipetting member immediately after breaking off the break-off end area of the ampule. Further intermediate steps, such as a transfer into an empty pipette, can be dispensed with. The application of the liquid is thus considerably facilitated compared to previous solutions.

The elastically deformable element is preferably made of plastic or a paper material or of a composite material comprising plastic and/or paper or paperboard. It is also contemplated that the material of the elastically deformable element my comprise wadding. The pipetting member, which is made of a paper or paperboard material, has advantages in particular with regard to sustainability.

In a specific embodiment of the pipette according to the disclosure, the pipetting member comprises a collar through which the break-off end area of the ampule extends. In this case, the pipetting member is open on the side of the outlet opening resulting from the breaking off of the end area. After breaking off the break-off area, the liquid held in the reservoir space of the ampule can flow into the volume formed by the collar and be applied to the surface in question via the discharge opening formed by the collar by exerting lateral pressure.

The collar, which can extend partially or entirely across the cylindrical circumferential wall of the ampule, is preferably made of an elastic plastic material, such as silicone. In the as-delivered state, the discharge opening is stretched open by the break-off end area of the ampule. After the end area has been broken off, the material of the collar contracts in such a manner that the discharge opening has a diameter that is greatly reduced compared to the as-delivered state and the liquid that has flowed out of the ampule into the volume of the collar can be applied dropwise by exerting suitable lateral pressure.

In order to unambiguously define the position of the collar in the as-delivered state of the pipette, it is advantageous if the ampule has a neck in an area of transition between the break-off end area, which represents a shapeable ampule tip, and the cylindrical circumferential wall, an edge area of the pipetting member being in circumferential contact with the neck. In the region of the neck, the ampule preferably has an annular predetermined breaking point or zone, along which the break-off end area is designed to break off from the area of the ampule defining the reservoir space.

In order to further facilitate the use of the pipette according to the disclosure, it is advantageous if the edge area, which is in circumferential contact with the neck of the ampule, is part of a portion of the collar that is folded over inward and that is externally surrounded by a central area of the collar. In the as-delivered state, the collar is thus double-layered in the area in question, the collar forming a collar of the pipette according to the disclosure that extends from the neck of the ampule.

In a specific embodiment, a material strip which forms a fluid conduit when the end area of the ampule is broken off, is disposed between the folded-over portion and the central area of the collar in order to be able to transfer the liquid in a targeted manner into the volume defined by the collar or the pipetting member after opening the ampule, i.e., after breaking off the end area. The material strip is preferably inserted circumferentially in the intermediate space between the folded-over portion and the central area and is formed by a plastic film or a paper strip, for example.

In another advantageous embodiment of the prefilled pipette according to the disclosure, the collar, when the end area has been broken off, forms a balloon-like pipetting portion which has the discharge opening on its side facing away from the ampule. The pipetting portion is formed by breaking off the end area and removing it by pulling the edge area of the collar, which is in contact with the end area, away from the reservoir space of the ampule. When the broken-off end area is then pulled out of the collar, the collar, which is made in particular of silicone or a similar material, contracts in such a manner that only a small-diameter discharge opening remains, via which the liquid can be applied in a targeted manner.

In another specific embodiment of the pipette according to the disclosure, the ampule has two break-off end areas, which are shapeable ampule tips and which can be broken off in particular along respective annular predetermined breaking points or zones, one of the tip-like break-off end areas being accommodated by the pipetting member. The pipetting member in particular encloses a volume filled only with air and is configured to be compressible, so that the end area in question can be broken off by manual operation via the pipetting member. When both end areas of the ampule have been broken off, the pipetting member can be compressed by exerting lateral and/or axial pressure, allowing the liquid held in the ampule to be displaced out of the ampule and applied. The outlet opening is created on the side of one of the end areas at the predetermined breaking point in question by breaking off this end area.

In a particular embodiment of the pipette according to the disclosure, the tip-like end area of the ampule not accommodated by the pipetting member is exposed. This means that the liquid is applied directly via the outlet opening, which is created by breaking off the exposed end area of the ampule.

In an alternative embodiment of the pipette according to the disclosure, an applicator member can be plugged on the ampule in such a manner that the end area not accommodated by the pipetting member is covered.

Furthermore, it is contemplated that the pipetting member may be disposed on the side of the outlet opening of the ampule. In this case, the liquid flows out of the ampule into the pipetting member, which defines a volume, after the two tip-like break-off end areas have been broken off. By applying lateral pressure, the liquid can then be applied through a discharge opening disposed on the pipetting member.

In another specific embodiment of the pipette according to the disclosure, the applicator member and the pipetting member are each press-fit directly to the ampule independently of each another, the ampule being circumferentially exposed in an area disposed between the applicator member and the pipetting member.

Further advantages and advantageous embodiments of the subject matter of the invention can be found in the description, the drawings and the claims. All combinations of at least two features disclosed in the description, the claims and/or the figures fall within the scope of the invention; i.e., any feature disclosed in the description can be part of the claimed subject matter independently of the other features and/or specifications disclosed in the context in question.

### BRIEF DESCRIPTION OF THE FIGURES

Exemplary embodiments of the subject matter of the invention are shown in a schematically simplified manner in the drawings and will be explained in more detail in the following description.

FIG. 1 is a perspective view of a pipette in the as-delivered state.

FIG. 2 shows the pipette according to FIG. 1 in the activated state.

FIG. 3 is a longitudinal section through the pipette according to FIG. 1 in the as-delivered state.

FIG. 4 is a longitudinal section through the pipette according to FIG. 1 in the activated state.

FIG. 5 shows the pipette according to FIG. 1 in the disassembled state.

FIG. 6 is a longitudinal section through a second embodiment of a pipette in its as-delivered state.

FIG. 7 is a longitudinal section of the pipette according to FIG. 6 in its activated state.

FIG. 8 is a perspective view of the pipette according to FIG. 6 in the disassembled state.

FIG. 9 is a perspective view of a third embodiment of a pipette in the as-delivered state.

FIG. 10 is the pipette according to FIG. 9 in the activated state.

FIG. 11 is a longitudinal section through the pipette according to FIG. 9 in the as-delivered state.

FIG. 12 is a longitudinal section through the pipette according to FIG. 9 in the activated state.

FIG. 13 is a longitudinal section through a fourth embodiment of a pipette in the as-delivered state.

FIG. 14 is a longitudinal section through the pipette according to FIG. 13 in the activated state.

FIG. 15 shows the pipette according to FIG. 13 in the disassembled state.

FIG. 16 is a perspective view of a fifth embodiment of a pipette.

FIG. 17 is a longitudinal section through the pipette according to FIG. 16.

FIG. 18 is a perspective view of a sixth embodiment of a pipette.

FIG. 19 is a longitudinal section through the pipette of FIG. 18.

FIG. 20 is a perspective view of a seventh embodiment of a pipette.

FIG. 21 is a longitudinal section through the pipette according to FIG. 20.

FIG. 22 is a perspective view of an eighth embodiment of a pipette.

FIG. 23 is a longitudinal section through the pipette according to FIG. 22.

FIG. 24 is a perspective view of a ninth embodiment of a pipette.

FIG. 25 is a longitudinal section through the pipette according to FIG. 24.

FIG. 26 is a perspective view of a tenth embodiment of a pipette.

FIG. 27 is a longitudinal section through the pipette according to FIG. 26.

FIG. 28 is a perspective view of an eleventh embodiment of a pipette.

FIG. 29 is a longitudinal section through the pipette of FIG. 28.

FIG. 30 is a perspective view of a twelfth embodiment of a pipette.

FIG. 31 is a longitudinal section through the pipette of FIG. 30.

FIG. 32 is a perspective view of a thirteenth embodiment of a pipette.

FIG. 33 is a longitudinal section through the pipette according to FIG. 32.

FIG. 34 is a perspective view of a fourteenth embodiment of a pipette.

FIG. 35 is a longitudinal section through the pipette according to FIG. 34.

FIG. 36 is a perspective view of a fifteenth embodiment of a pipette.

FIG. 37 is a longitudinal section through the pipette according to FIG. 36.

FIG. 38 is a perspective view of a sixteenth embodiment of a pipette.

FIG. 39 is a longitudinal section through the pipette of FIG. 38.

FIG. 40 is a perspective view of a seventeenth embodiment of a pipette.

FIG. 41 is a longitudinal section through the pipette of FIG. 40.

### DETAILED DESCRIPTION

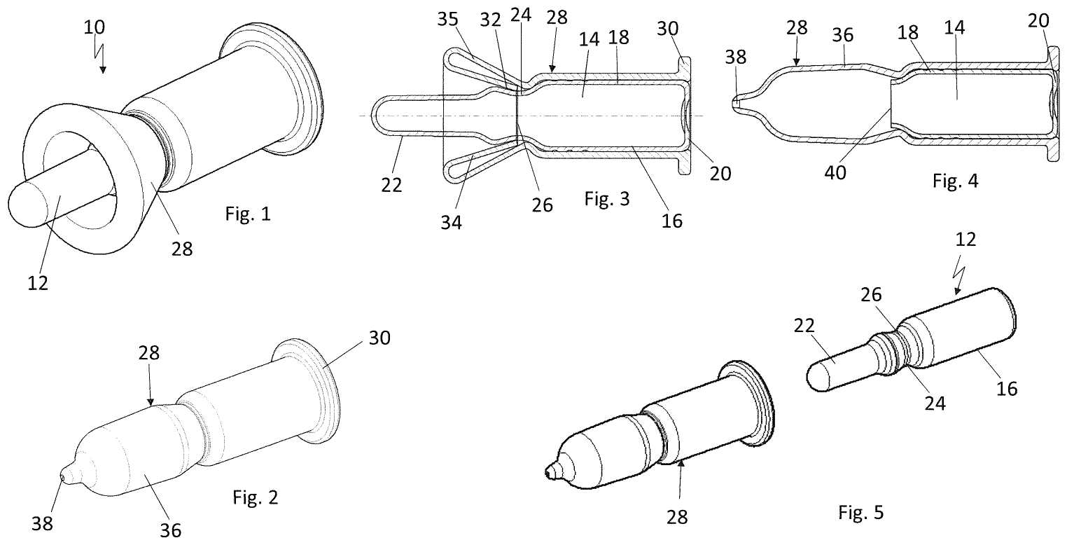

FIGS. 1 to 5 illustrate an applicator 10 that forms a prefilled pipette according to the disclosure and that comprises an ampule 12 which, in the closed state, holds a liquid to be applied in a reservoir space 14. The ampule 12 comprises an ampule body 16 which has a cylindrical circumferential wall 18 and a bottom 20. On the side facing away from the bottom 20, the ampule body 16 is adjoined by a break-off end area 22 which forms what is referred to as an ampule tip and which is connected to the ampule body 16 via a neck 24. In the area of the neck 24, the ampule 12 has a predetermined breaking point 26 designed as a ring line along which the break-off end area 22 of the ampule body 16 can be broken off in a defined manner.

The applicator 10 comprises a pipetting member 28, which is formed as a collar or sleeve of the ampule 12 and circumferentially delimits the cylindrical circumferential wall 18 up to the area of the bottom 20. In the area of the bottom 20, the pipetting member 28 forms a foot area formed by an annular collar 30.

As can be seen in FIGS. 1 and 3 in particular, the break-off end area 22 extends through the pipetting member 28, which is designed as a collar, in the as-delivered state of the applicator 10, an edge area 32 of the pipetting member 28, which is made of a silicone material or another suitable elastically deformable plastic material, is in contact with the ampule 12 in the area of the neck 24. The edge area 32 is part of a portion 34 of the pipetting member 28 that is folded over in the direction of the ampule 12 and that is surrounded by a central area 36 of the pipetting member 28 on the outside in relation to the ampule 12. So the pipetting member 28 is of a double-wall design in the area surrounding the end area 22 in the as-delivered state. Starting from the neck 24 of the ampule 12, this double-walled portion forms a collar or skirt, which surrounds the end area 22 of the ampule 12.

When the applicator 10 is to be activated, the break-off end area 22 is broken off from the ampule body 16 along the predetermined breaking point 26 and pulled out of the collar-like pipetting member 28 in the direction away from the ampule body 16. In this process, the inwardly folded portion 34 of the pipetting member is also pulled in the direction away from the ampule body 16, causing a pipetting portion 36 to be formed, which is shown in detail in FIGS. 2 and 4, the pipetting portion 36 being balloon-like and having a discharge opening 38. The liquid held in the reservoir space 14 of the ampule 12 can flow into the pipetting portion 36 through an outlet opening 40 of the ampule 12, which is formed after the end area 22 has been broken off. By exerting manual lateral pressure to the pipetting portion 36, the liquid can then be applied, in particular dropwise, through the discharge opening 38.

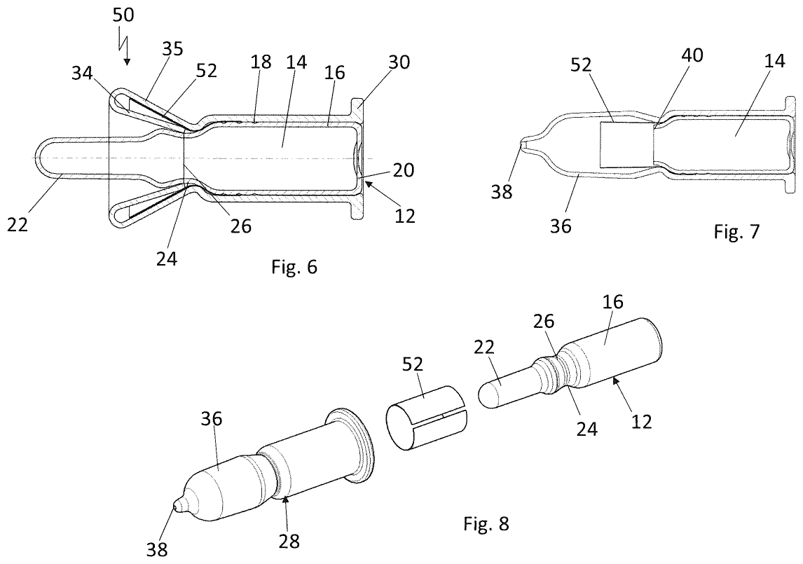

FIGS. 6 to 8 show an applicator 50 which essentially corresponds to that shown in FIGS. 1 to 5, but differs from it in that it additionally comprises a material strip 52, which may be formed by a plastic film and is disposed between the inwardly folded-over portion 34 and the central portion 35 of the pipetting member 28 in a funnel-like manner or following a conical surface in the as-delivered state shown in FIG. 6. When breaking off and removing the end area 22 of the ampule 12 and deforming the pipetting member 28 as described in the exemplary embodiment above, the material strip 52 is also deformed to the effect that it connects cylindrically to the outlet opening 40 and forms a fluid conduit via which the liquid is guided out of the reservoir space 14 of the ampule 12 into the pipetting portion 36 of the pipetting member 28.

Otherwise, the applicator 50 corresponds to that shown in FIGS. 1 to 5, which is why, in order to avoid repetition, reference is made to the related embodiment.

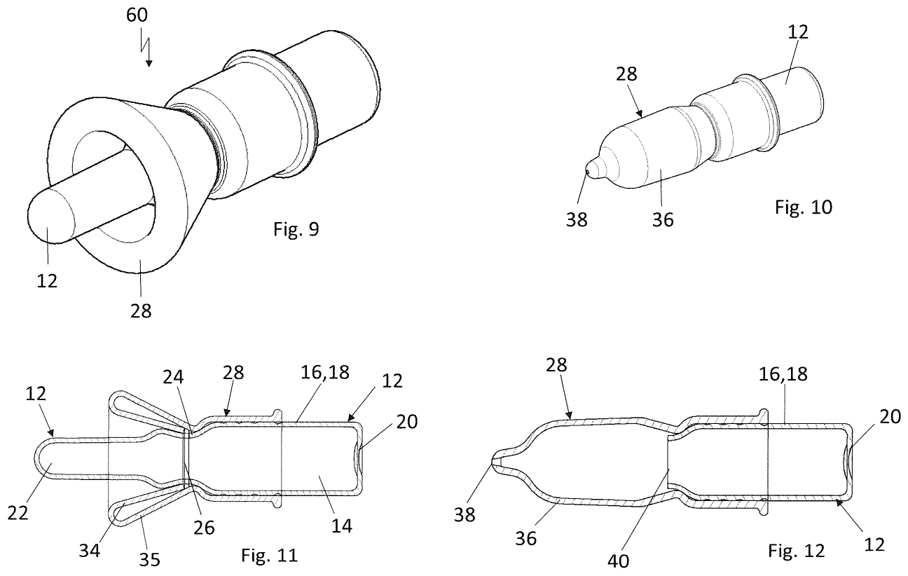

FIGS. 9 to 12 show an applicator 60 which largely corresponds to that shown in FIGS. 1 to 5, but differs from it in that it has a pipetting member 28 which does not extend as far as to the bottom 20 of the ampule 12, but only over a partial area of the circumferential wall 18 of the ampule body 16. Otherwise, the applicator 60 corresponds to that shown in FIGS. 1 to 5, which is why, in order to avoid repetition, reference is made to the description relating thereto.

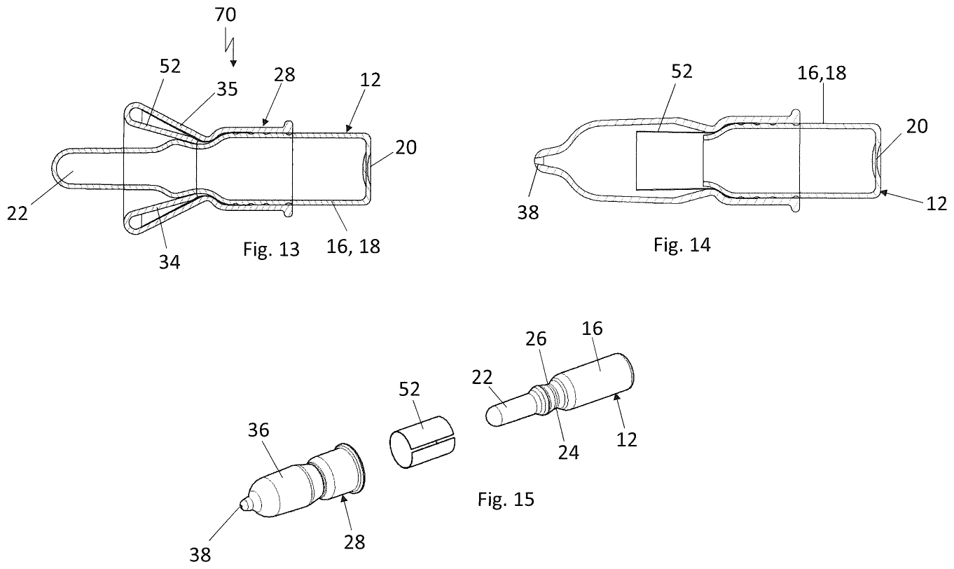

FIGS. 13 to 15 show an applicator 70 which again largely corresponds to that shown in FIGS. 1 to 5, but differs from it in that, in accordance with the embodiment shown in FIGS. 6 to 8, it comprises a material strip 52 for forming a fluid conduit and, in accordance with the embodiment shown in FIGS. 9 to 12, it is provided with a pipetting member 28 which extends only across part of the cylindrical circumferential wall 18 of the ampule 12. Otherwise, the applicator 70 according to FIGS. 13 to 15 corresponds to the embodiments described above, which is why reference is made to the description relating thereto.

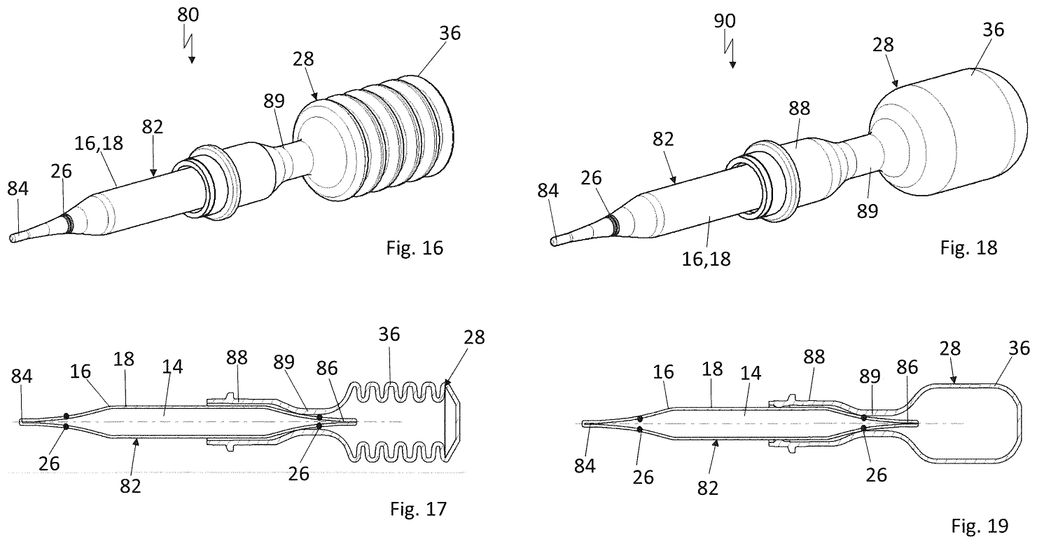

FIGS. 16 and 17 show an applicator 80 which is a prefilled pipette and has an ampule 82 in the form of what is referred to as a bitip, the ampule 82 having a cylindrical circumferential wall 18 which delimits a reservoir space 14 in which a liquid to be applied is held. The ampule 82 has two break-off end areas 84 and 86, which are each designed as an ampule tip and which are designed to break off from the ampule body 16 formed by the circumferential wall 18 along an annular predetermined breaking point 26. By breaking off the end area 84, which is at the front in relation to the direction of application, an outlet opening with a small diameter forms on the ampule 18. By breaking off the rear end area 86, a rear opening of the ampule 82 is formed, via which air pressure can be exerted on the liquid held in the reservoir space 14.

The applicator 80 further comprises a pipetting member 28, which comprises an essentially cylindrical fixation area 88 which encloses the circumferential wall 18 of the ampule 82 and which is thus connected to the ampule 82 in a press fit. Starting from the fixation area 88, the pipetting member 28 extends towards the rear in the direction away from the end area 84, namely via a neck 89 into a balloon-like pipetting portion 36, which is designed in the manner of a corrugated bellows or a folding bellows and is compressible in the axial direction of the applicator 80. The predetermined breaking point 26 of the end portion 86 is disposed in the area of the neck 89, so liquid which inadvertently enters the balloon-like pipetting portion 36 after the end area 86 has been broken off can flow back into the ampule 82. Instead of a neck, the pipetting member 28 can also have an inner geometry with which the ampule 82 is in contact in the area of the predetermined breaking point 26 of the end area 86 and which ensures that the liquid flows back into the ampule 82 when the end area 86 has been broken off.

To activate the applicator 80, the two tip-like end areas 84 and 86 of the ampule 82 are broken off, during which the rear end area 86 can be grasped via the pipetting member 28, which is made of a flexible plastic material or flexible paper-containing material. By exerting axial pressure on the pipetting portion 36 of the pipetting member 28, the liquid can subsequently be applied from the reservoir space 14 through the front outlet opening of the ampule 82, which has been formed by breaking off the front end portion 84 along its predetermined breaking point.

FIGS. 18 and 19 show an applicator 90, which essentially corresponds to that shown in FIGS. 16 and 17, but differs from it in that, instead of a bellows-like pipetting portion, it has a balloon-like pipetting portion 36 which can be compressed in particular by lateral pressure. When the end areas 84 and 86 of the ampule 82 have been broken off, the liquid held in the reservoir space 14 of the ampule 82 can be applied by means of the lateral pressure. Otherwise, the applicator 90 corresponds to that shown in FIGS. 16 and 17, which is why, in order to avoid repetition, reference is made to the description relating thereto.

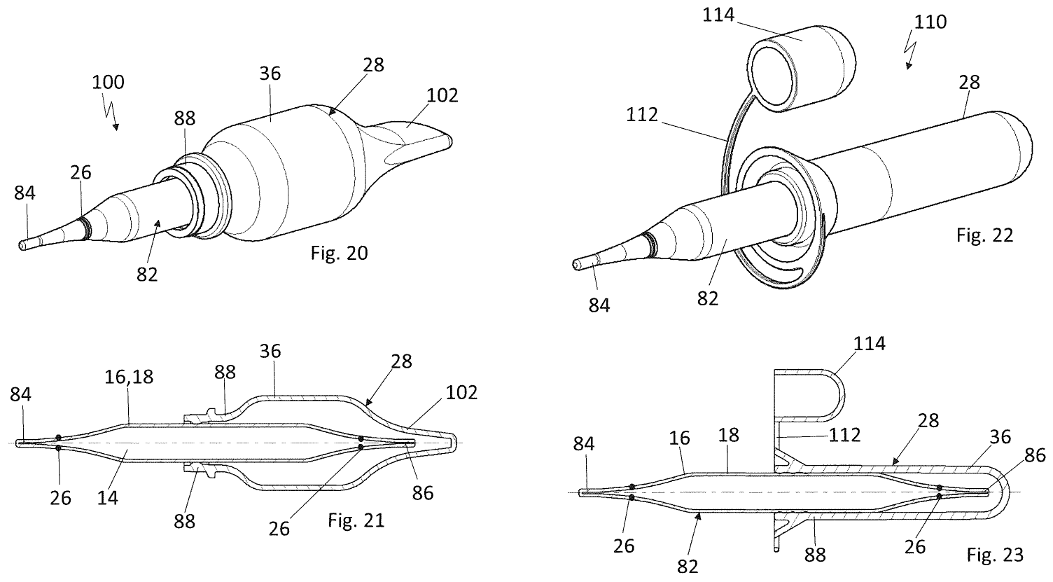

FIGS. 20 and 21 show an applicator 100, which also largely corresponds to that shown in FIGS. 16 and 17, but differs from it in the design of the pipetting member 28. The pipetting member 28 has a short fixation area 88, which is in contact with the cylindrical circumferential wall 18 of the ampule 82 in a press fit. The fixation area 88 is followed by a balloon-like, widened pipetting portion 36, which transitions into a tongue-like, tapered activating portion 102, in which the rear break-off end area 86 of the ampule 82 engages. To activate the applicator 100, the rear tip-like end area 86 is broken off by manually gripping the activating portion 102 of the pipetting member 28. After the front end area 84 has been broken off, the liquid held in the ampule 12 can be applied via the outlet opening created on the side of the end area 84 by exerting manual lateral pressure on the balloon-like pipetting portion 36.

Since the applicator 100 is otherwise the same as that shown in FIGS. 16 and 17, reference is made to the description relating thereto.

FIGS. 22 and 23 show an applicator 110, which again largely corresponds to that shown in FIGS. 16 and 17, but differs from it in that, in addition to the identically designed ampule 82, it comprises a pipetting member 2 8 which is made of a plastic and/or paper material and which is tubular in shape and engages around the cylindrical circumferential wall 18 of the ampule 82 with a front fixation area 88 and forms a pipetting portion 36 with a rear closed area, in which the rear end area 86 of the ampule 82 is also disposed. Since it is made of elastically deformable plastic and/or paper, the pipetting portion 36 can be deformed both to break off the end area 86 and to pipette or apply the liquid held in the ampule 82 when the tip-like end areas 84 and 86 have been broken off. Furthermore, the pipetting member 28 has a cap 114 which is molded on via a string-like connecting area 112 and by means of which the ampule 82 can be resealed after activation on the side of the end area 84 after it has been broken off.

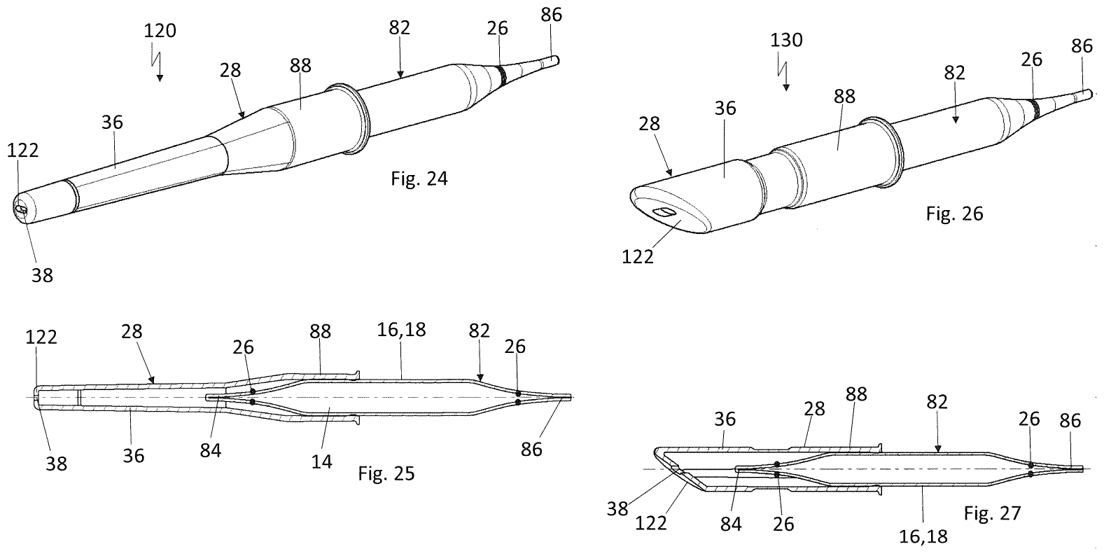

FIGS. 24 and 25 show an applicator 120, which comprises an ampule 82 of the type shown in FIGS. 16 and 17. Furthermore, the applicator comprises a pipetting member 28 which is made of a plastic and/or paper material and which is placed on the front end of the ampule 82, which comprises the break-off end area 84, the breaking off of which forms an outlet opening of the ampule 82. The pipetting member 28 is simultaneously an applicator member and comprises a fixation area 88, which is press-fitted onto the cylindrical circumferential wall 18 of the ampule 82. At the end facing away from the fixation area 88, the tubular pipetting member 28 comprises a discharge opening 38, via which the liquid held in the ampule 82 can be applied. For activation, the two tip-like end areas 84 and 86 of the ampule 82 are each broken off along the respective predetermined breaking points. This allows the liquid to flow out of the reservoir space 14 of the ampule 82 into a pipetting portion 36 of the pipetting member 28. By exerting lateral pressure on the pipetting portion 36, the liquid can then be applied via the discharge opening 38.

FIGS. 26 and 27 show an applicator 130, which essentially corresponds to that shown in FIGS. 24 and 25, but differs from it in that it has a pipetting member 28 which does not form a funnel-like tube but a cylindrical tube, which is provided with an end-face wall 122 that is inclined with respect to the axis of the applicator 130 and on which a discharge opening 38 is formed. Otherwise, the applicator 130 corresponds to that shown in FIGS. 24 and 25, which is why reference is made to the description relating thereto.

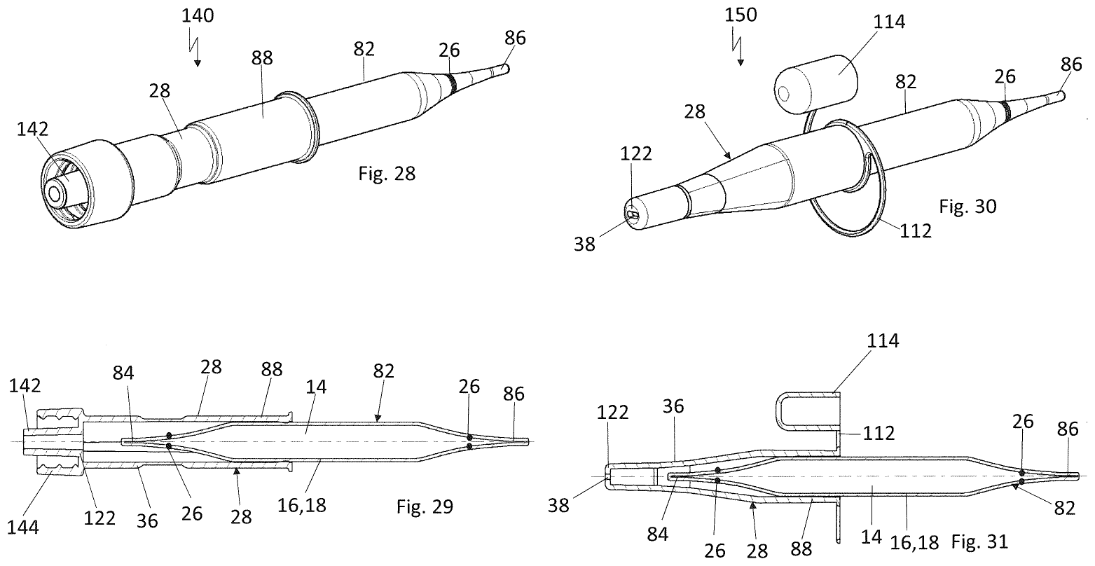

FIGS. 28 and 29 show an applicator 140, which again largely corresponds to that shown in FIGS. 24 and 25, but differs from it in that it again has a pipetting member 28 which is made of a plastic and/or paper material and which is designed as a cylindrical tube which is plugged onto the ampule 82 and which is formed from an elastically deformable plastic. The pipetting member 28 in turn comprises an end-face wall 122, on which a Luer cone 142 and a fixing portion 144 provided with an internal thread are formed, so that an application aid, such as a cannula or the like, can be fixed to the pipetting member 28. Otherwise, the applicator 140 corresponds to that shown in FIGS. 24 and 25, which is why, in order to avoid repetition, reference is made to the related embodiment.

FIGS. 30 and 31 show an applicator 150 which largely corresponds to that shown in FIGS. 24 and 25, but differs from it in that it also has a cap 114 which is molded onto the pipetting member 28, made of a plastic and/or paper material, via a string-like connecting area 112. By means of the cap 114, the ampule 82 can be closed again at the rear, i.e., on the side of the broken-off end area 86, after activation. Otherwise, the applicator 150 corresponds to that shown in FIGS. 24 and 25, which is why reference is made to the description relating thereto.

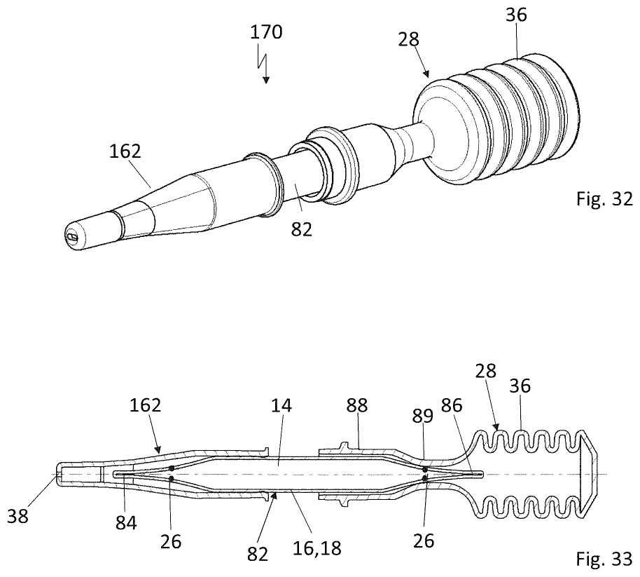

FIGS. 32 and 33 show an applicator 170 comprising an applicator member 162 at the front and a pipetting member 28 at the rear, which is designed according to the bellows-like pipetting member according to FIGS. 16 and 17, reference being made to the description. The applicator member 162 is placed onto the ampule 82 from the front, the ampule 82 being designed according to the embodiment of FIGS. 20 and 21, so it covers the front break-off end area 84 of the ampule 82. The pipetting member 28, which is made of a plastic and/or paper material, and the applicator member 162, which is made of a plastic and/or paper material, are each press-fit directly to the ampule 82 independently of each other. The applicator 160 is activated by manually breaking off the tip-like end areas 84 and 86 via the pipetting member 82 and the applicator member 162. Subsequently, the liquid can be applied from the ampule 82 through the discharge opening 38 of the applicator member 162 by exerting lateral pressure on the pipetting member 28.

A ring-like area of the ampule 82 which is disposed between the pipetting member 28 and the applicator member 162 is exposed, meaning the applicator member 162 and the pipetting member 28 are not in contact with each other.

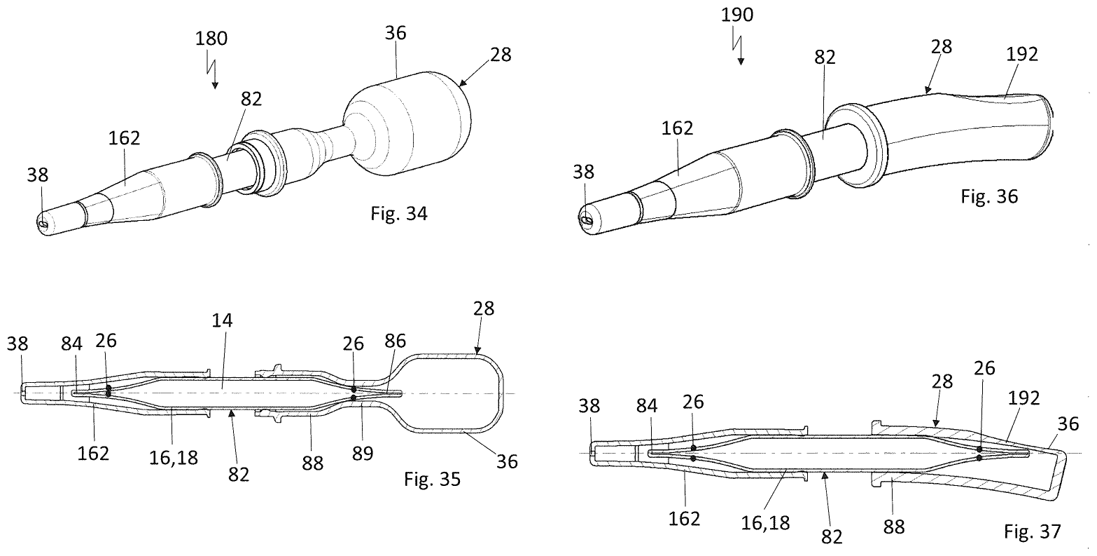

FIGS. 34 and 35 show an applicator 180 that largely corresponds to that shown in FIGS. 33 and 34, but differs from it in the design of the pipetting member 28, which is made of a plastic and/or paper material and has a balloon-like pipetting portion 36 instead of a bellows-like pipetting portion. Otherwise, the applicator 180 corresponds to that shown in FIGS. 34 and 35, which is why reference is made to the description relating thereto.

FIGS. 36 and 37 show an applicator 190 which, in turn, largely corresponds to that shown in FIGS. 32 and 33, but differs from it in that it has a tube-like pipetting member 28 which is made of a plastic and/or paper material and which has a gripping notch 192 on one side.

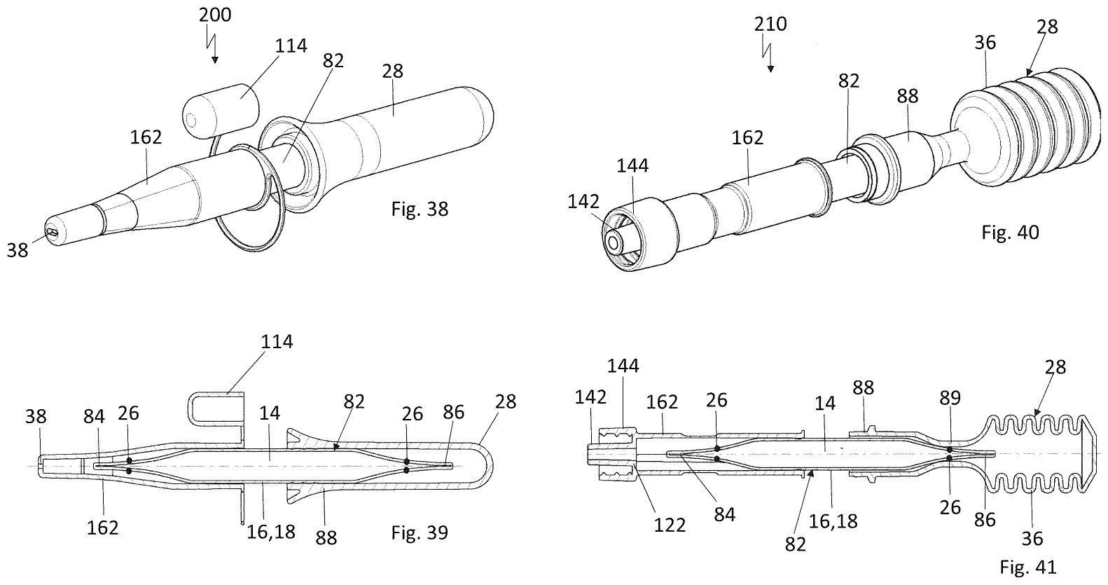

FIGS. 38 and 39 show an applicator 200 that largely corresponds to that shown in FIGS. 36 and 37, but differs from it in that it comprises an applicator member 162 whose design corresponds to that of the pipetting member of the embodiment shown in FIGS. 30 and 31, which is why reference is made to the description relating thereto. In addition, the applicator 200 has a pipetting member 28 which is made of a plastic and/or paper material and which is designed in the manner of a tube corresponding to the pipetting member of the embodiment according to FIGS. 22 and 23, but, in deviation therefrom, has no cap, since the cap 114 is molded onto the applicator member 162.

FIGS. 40 and 41 show an applicator 210 which, as an applicator member 162, comprises a tubular attachment of the ampule 82, which corresponds to the applicator shown in FIGS. 28 and 29, i.e., the one provided with a Luer cone 142 and a fixing portion 144 equipped with an internal thread. As a pipetting member 28, the applicator 210 comprises the pipetting member of the embodiment according to FIGS. 16 and 17, which is designed in the manner of a corrugated bellows and to whose description reference is made.

### REFERENCE SIGNS

10 applicator
12 ampule
14 reservoir space
16 ampule body
18 circumferential wall
20 bottom
22 end area
24 neck
26 predetermined breaking point
28 pipetting member
30 annular collar
32 edge area
34 portion
36 pipetting portion
38 discharge opening
40 outlet opening
50 applicator
52 material strip
60 applicator
70 applicator
80 applicator
82 ampule
84 end area
86 end area
88 fixation area
89 neck
90 applicator
100 applicator
102 activating portion
110 applicator
112 connecting area
114 cap
120 applicator
122 end-face wall
130 applicator
140 applicator
142 Luer cone
144 fixing portion
150 applicator
162 applicator member
170 applicator
180 applicator
190 applicator
192 gripping notch
200 applicator
210 applicator

What is claimed is:

1. A pipette comprising an ampule closed on all sides, the ampule having a reservoir space in which a liquid is held and which is delimited by an at least essentially cylindrical circumferential wall of the ampule, the ampule having at least one break-off end area, breaking off of the end area opening an outlet opening for the liquid, a pipetting member being provided, the pipetting member being formed by an elastically deformable element and being plugged onto the ampule in such a manner that it circumferentially delimits the cylindrical circumferential wall and the ampule, which is closed on all sides and filled with the liquid, is partially exposed.

2. The pipette according to claim 1, wherein the pipetting member comprises a collar through which the break-off end area of the ampule extends.

3. The pipette according to claim 2, wherein the ampule has a neck in an area of transition between the break-off end area and the cylindrical circumferential wall, an edge area of the pipetting member being in circumferential contact with the neck.

4. The pipette according to claim 3, wherein the edge area is part of a portion of the collar that is folded over inward and that is externally surrounded by a central area of the collar.

5. The pipette according to claim 4, wherein a material strip forming a fluid conduit when the end area of the ampule has been broken off is disposed between the folded-over portion and the central area of the collar.

6. The pipette according to claim 2, wherein, when the end area of the ampule has been broken off, the collar forms a balloon-like pipetting portion having a discharge opening on its side facing away from the ampule.

7. The pipette according to claim 1, wherein the ampule has two break-off end areas and one of the break-off end areas is accommodated in the pipetting member.

8. The pipette according to claim 7, wherein the other one of the break-off end areas is exposed.

9. The pipette according to claim 7, wherein an applicator member is plugged onto the ampule in such a manner that the other break-off end area is covered.

10. The pipette according to claim 9, wherein the applicator member and the pipetting member are each press-fit directly to the ampule independently of each other and the ampule is circumferentially exposed in an area disposed between the applicator member and the pipetting member.
